(19) United States
(12) Patent Application Publication
(10) Pub. No.: US 2016/0323367 A1
(43) Pub. Date: Nov. 3, 2016

(54) MASSIVELY-SCALABLE, ASYNCHRONOUS BACKEND CLOUD COMPUTING ARCHITECTURE

(71) Applicant: Lifespeed, Inc., Irvine, CA (US)

(72) Inventors: Nolan James Murtha, Los Angeles, CA (US); Matthew Allen Good, Aliso Viejo, CA (US); Chad Jason Thomas, Irvine, CA (US); Augustine Kagbindi Walker, Mission Viejo, CA (US); Ryan Matthew Smith, Irvine, CA (US)

(21) Appl. No.: 15/143,404

(22) Filed: Apr. 29, 2016

Related U.S. Application Data
(60) Provisional application No. 62/155,411, filed on Apr. 30, 2015.

(51) Int. Cl. H04L 29/08; H04L 12/911

(52) U.S. Cl. CPC H04L 67/1002; H04L 67/1097; H04L 47/70

(57) ABSTRACT

Embodiments include a cloud-based computing architecture that includes successive layers configured to process asynchronous requests received from applications. Each layer includes a load balancer configured to balance a load of the layer independent of any other layer of the successive layers. The cloud-based computing architecture includes channels communicatively coupling the successive layers such that any layer of the successive layers is configured to communicate asynchronously with a successive layer over one or more channels of the channels.

### CROSS-REFERENCE TO RELATED APPLICATION

This application claims priority to U.S. Provisional Patent Application Ser. No. 62/155,411, filed Apr. 30, 2015, which is incorporated herein in its entirety by this reference.

### TECHNICAL FIELD

The disclosed teachings generally relate to a backend cloud service. The disclosed teachings more specifically relate to a massively-scalable, asynchronous backend cloud service.

### BACKGROUND

Cloud computing enables ubiquitous, on-demand access to a shared pool of configurable computing resources (e.g., networks, servers, storage, applications, and services), which can be rapidly provisioned and released with minimal management effort. Cloud computing services can facilitate the processing of millions, hundreds of millions, or even billions of records while optimizing the performance of data loads and integration into a company's services.

Some of the challenges facing cloud computing include speed, scalability, and reliability. Many cloud-based applications are bandwidth intensive, and many potential cloud customers are waiting for improved bandwidth before they consider moving into the cloud. Many potential cloud customers avoid using cloud services for their business's critical infrastructure because the services that the cloud providers offer do not sufficiently guarantee scalability and reliability. Examples of such customers are healthcare service providers that need unrestricted capacity and storage to continuously add more patients and patient information such as medical records and health-related content.

### SUMMARY

Introduced here are at least one cloud-based computing architecture and at least one method. The at least one cloud-based computing architecture includes successive layers configured to process asynchronous requests received from applications. Each layer includes a load balancer configured to independently balance a load of the layer independent of the other successive layers. The cloud-based computing architecture includes channels communicatively coupling the successive layers such that any layer of the successive layers is configured to communicate asynchronously with a successive layer over one or more channels of the channels.

In some embodiments, a method performed by a cloud-based computing architecture having successive layers includes receiving one or more messages asynchronously from applications. The message(s) are received by an initial layer of the successive layers. The method also includes processing the message(s) by asynchronously communicating in successive order by each layer, and independently balancing a workload of an individual layer independent of other layers by checking one or more timestamps of the message(s) when processed by the individual layer. The method further includes pushing updates from a final layer of the successive layers to the applications based on the message(s), and causing the applications to update with the updates without having queried for the updates.

In some embodiments, a method is performed by a monitoring system operable to monitor a cloud-based computing architecture including successive layers. The method includes inputting a test message into a layer of the successive layers of the cloud-based computing architecture, monitoring a workload of the layer by gathering performance data based on the test message, and signaling the layer to create one or more new processes or terminate one or more existing processes within the layer, depending on the performance data.

Other aspects of the disclosed embodiments will be apparent from the accompanying figures and detailed description.

This Summary is provided to introduce a selection of concepts in a simplified form that are further explained below in the Detailed Description. This Summary is not intended to identify key features or essential features of the claimed subject matter, nor is it intended to be used to limit the scope of the claimed subject matter.

### BRIEF DESCRIPTION OF THE DRAWINGS

These and other objects, features, and characteristics will become more apparent to those skilled in the art from a study of the following Detailed Description in conjunction with the appended claims and drawings, all of which form a part of this specification. While the accompanying drawings include illustrations of various embodiments, the drawings are not intended to limit the claimed subject matter.

FIG. 1 is a block diagram of a system including a backend cloud computing architecture according to some embodiments of the present disclosure;

FIG. 2 is a block diagram of a cloud computing architecture including successive layers that receive and process messages asynchronously according to some embodiments of the present disclosure;

FIG. 3 is a flowchart illustrating a process performed by the computing architecture of the backend cloud system according to some embodiments of the present disclosure;

FIG. 4 is a flowchart illustrating a process performed by the cloud computing architecture for load balancing according to some embodiments of the present disclosure;

FIG. 5 is a block diagram of a web application program interface (API) cluster layer of the cloud computing architecture according to some embodiments of the present disclosure;

FIG. 6 is a block diagram of a message queue (MQ) cluster layer of the cloud computing architecture according to some embodiments of the present disclosure;

FIG. 7 is a block diagram of a micro service cluster layer of the cloud-computing architecture according to some embodiments of the present disclosure;

FIG. 8 is a block diagram of a database cluster layer of the cloud computing architecture according to some embodiments of the present disclosure;

FIG. 9 is a block diagram including a monitoring system that can automatically monitor the layers of the computing architecture of the backend cloud system according to some embodiments of the present disclosure;

FIG. 10 is a block diagram of different services provided by the monitoring system of FIG. 9 according to some embodiments of the present disclosure;

FIG. 11 is a flowchart of a process for workload balancing performed by the monitoring system according to some embodiments of the present disclosure; and

FIG. 12 is a block diagram illustrating a computer system operable to implement instructions causing the computer system to perform the disclosed technologies according to some embodiments of the present disclosure.

### DETAILED DESCRIPTION

Disclosed are at least one embodiment of a computing architecture and a method for providing fast, massively scalable, and reliable cloud service that is enabled to communicate asynchronously with user applications. The embodiments set forth below represent the necessary information to enable those skilled in the art to practice the embodiments, and illustrate the best mode of practicing the embodiments. In the following description, for the purposes of explanation, numerous specific details are set forth in order to provide a thorough understanding of the embodiments of the invention. One skilled in the art will recognize that the embodiments of the invention may be practiced without these specific details or with an equivalent arrangement.

In other instances, well-known structures and devices are shown in block diagram form in order to avoid unnecessarily obscuring the embodiments of the invention. Upon reading the following description in light of the accompanying figures, those skilled in the art will understand the concepts of the disclosure and will recognize applications of these concepts that are not particularly addressed here. It should be understood that these concepts and applications fall within the scope of the disclosure and the accompanying claims.

The purpose of terminology used herein is only for describing embodiments and is not intended to limit the scope of the disclosure. Where context permits, words using the singular or plural form may also include the plural or singular form, respectively. The word “or,” in reference to a list of two or more items, covers all of the following interpretations of the word: any of the items in the list, all of the items in the list, and any combination of the items in the list.

Computing mechanisms for processing and storing large volumes of content are crucial to modern service providers. For example, health-related service providers administer applications to users (e.g., healthcare providers or patients) that need access to volumes of content on demand. The applications can be provided to users through a portal (e.g., website) to access health-related content. The health-related service providers may need to continuously add more users (e.g., patients) and curate their content.

Curating large volumes of content requires a complex scalable computing infrastructure that is cost prohibitive to many organizations. As such, these organizations turn to multi-tenant cloud computing to use a shared pool of configurable computing resources that provide scalable services for many applications. Cloud-based applications can be accessible through a portal (e.g., a website) connected to a cloud infrastructure over a network. The portal may provide features such as analytics to provide insights into content. Although a cloud-based infrastructure provides greater scalability that is more affordable compared to single-tenant systems, these benefits are becoming more constrained by the rapidly expanding number of users and volumes of content.

Disclosed embodiments include a cloud computing architecture that includes successive layers that can process asynchronous requests received from applications over a network. In some embodiments, each layer includes a load balancer configured to balance a load of the layer independent of any of the other layers. In some embodiments, the cloud-based computing architecture includes channels that couple the successive layers such that any of the layers can communicate asynchronously with a successive layer over a channel.

The disclosed embodiments also include a monitoring system that can monitor the cloud computing architecture. The monitoring system can operate by inputting a test message into a layer of the successive layers, and monitoring a workload of the layer by gathering performance data based on the test message. The monitoring system can then signal the layer to create new processes or terminate existing processes within the layer, depending on the performance data. As such, the disclosed embodiments provide a massively-scalable, asynchronous backend cloud service.

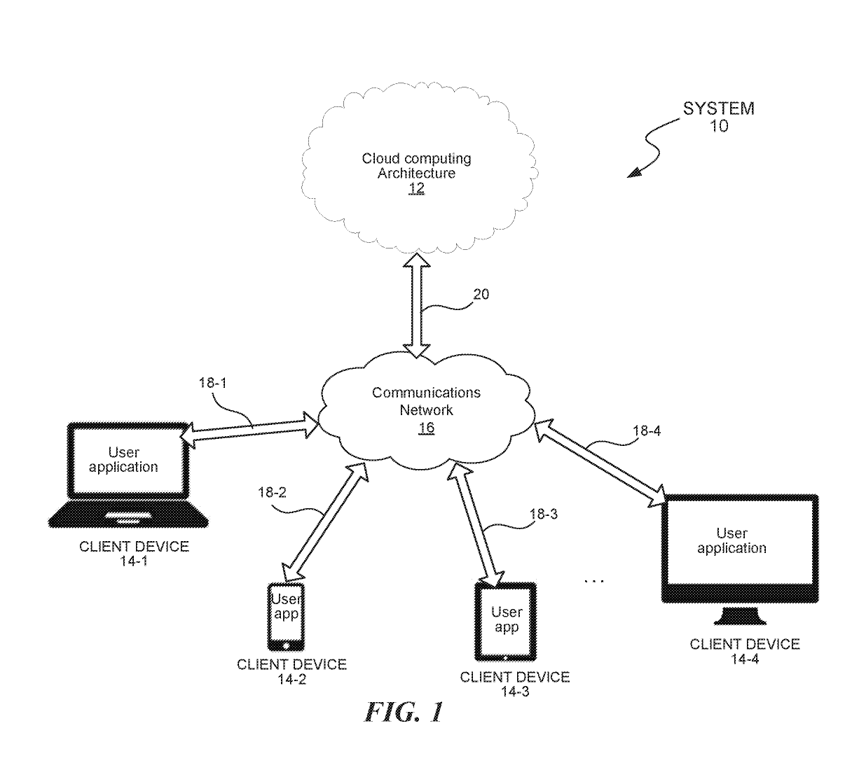

FIG. 1 is a block diagram of a system 10 including a backend cloud computing architecture 12 according to some embodiments of the present disclosure. The system 10 includes components such as a cloud computing architecture 12, and one or more client devices 14 (e.g., client devices 14-1 through 14-4) that provide user applications (e.g., mobile apps), all of which are interconnected over a communications network 16 (hereinafter “network 16”). In particular, the client devices 14 communicate with the network 16 over channels 18 (e.g., channels 18-1 through 18-4), and the cloud computing architecture 12 communicates with the network 16 over channel 20.

The system 10 can include one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network (e.g., a proprietary cable or fiber-optic network), and the like, or any combination thereof.

In addition, the wireless network may be, for example, a cellular network and may employ various technologies, including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, for example, worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

For example, the network 16 may include any combination of private, public, wired, or wireless portions. Data communicated over the network 16 may be encrypted or unencrypted at various locations or along different portions of the network 16. Each component of the system 10 may include combinations of hardware and/or software to process data, perform functions, communicate over the network 16, and the like.

For example, any component of the system 10 may include a processor, memory or storage, a network transceiver, a display, an operating system, and application software (e.g., for providing a user portal), and the like. Other components, hardware, and/or software included in the system 10 are well known to persons skilled in the art and, as such, are not shown or discussed herein.

The system 10 includes a shared pool of configurable computing resources including servers, storage, applications, software platform, networks, services, and the like, to offer user applications to the client devices 14. The software platform supports multiple tenants that provide different services to users. The services can provide custom user applications to client devices 14.

The user applications can be built using a programming language supported by the cloud computing architecture 12. The user applications provide access to large volumes of content generated by people or organizations. For example, health services can require the processing and storing of large volumes of medical content generated by healthcare providers. Health services require scalability due to a continuously growing number of patients having related content. In some embodiments, content may include services or media including video, audio, images, text, software, and the like.

In some embodiments, user applications that communicate with the cloud computing architecture 12 can be included in a single-page application (“SPA”). An SPA can be a web app that loads a single HTML page and dynamically updates that page as the user interacts with the app.

Examples include health-related services that provide user applications to users using the client devices 14. Examples of health-related services include mechanisms for searching, curating, uploading or downloading health-related content for use by healthcare providers and patients. For example, user applications may provide a portal to store and/or retrieve medical information about patients.

In some embodiments, the user applications reside locally at the client devices 14, which access data from the cloud computing architecture 12. In some embodiments, the user applications can reside elsewhere in the system 10. The client devices 14 can access the user applications through a user portal administered via the cloud computing architecture 12. In some embodiments, a remote service provider uses the cloud computing architecture 12 over the network 16 as a platform to provide the user applications for the client devices 14.

A service provider may include one or more server computers included in and/or remote from the cloud computing architecture 12. For example, a health service provider can include servers that allow hospitals and patients to access content through the cloud computing architecture 12. The service provider may provide any number and type of user applications that can be implemented in the cloud computing architecture 12.

Large numbers of multiple user applications can concurrently connect to the cloud computing architecture 12 over the network 16. For example, the number of users concurrently accessing the user applications can exceed hundreds of thousands. The user applications available on the client devices 14 can communicate asynchronously with the cloud computing architecture 12 over the network 16. The user applications send asynchronous requests to the cloud computing architecture 12, which asynchronously sends request acknowledgments back to the user applications on the client devices 14.

The user applications on the client devices 14 can communicate with the cloud computing architecture 12, communicate with each other, and communicate with other components of the system 10 by using well-known, new, or still developing asynchronous protocols. In this context, an asynchronous protocol includes a set of rules defining how nodes of the system 10 interact with each other based on information sent over communication links. The asynchronous protocols allows multiple user requests to be processed concurrently, without blocking resources such as processing, memory, and network bandwidth. The asynchronous communication contributes to making the system 10 massively scalable.

The client devices 14 can include any type of mobile terminal, fixed terminal, or portable terminal, including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/camcorder, positioning device, television receiver, radio broadcast receiver, electronic book device, game device, the accessories and peripherals of these devices, or any combination thereof.

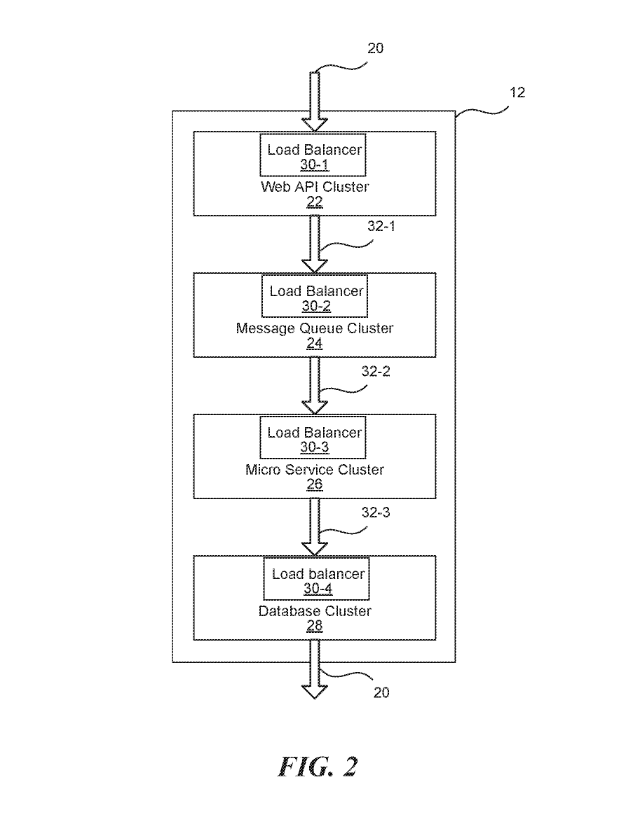

FIG. 2 is a block diagram of the cloud computing architecture 12 including successive layers that receive and process messages asynchronously according to some embodiments of the present disclosure. Each layer includes a cluster that contains an “N” number of computers and is scalable as needed. The cloud computing architecture 12 can include the following layers in successive order: a web API cluster layer 22, a message queue (MQ) cluster layer 24, a micro service cluster layer 26, and a database cluster layer 28 (also referred to collectively as “the layers” or “the successive layers” and individually as “a layer”).

Each layer includes a load balancer 30 (referred to collectively as load balancer 30 and individually as load balancer 30 or 30-1 through 30-4) that can balance a load of the layer independent of any other layer. The load is balanced based on an amount of work available to the layer. Balancing the loads of the layers contributes to making the cloud system massively scalable. Embodiments of the cloud computing architecture 12 may include additional layers or fewer layers than those shown in FIG. 2.

The web API cluster layer 22 can receive a number of asynchronous requests from one or more user applications over the channel 20 and send asynchronous request acknowledgments back to the user applications. Each layer communicates with a next layer in succession through one or more asynchronous channels 32. Lastly, the database cluster layer 28 pushes newly available information to the user applications via the channel 20. The user applications can be automatically updated with the newly available information. The user applications do not have to query the cloud computing architecture 12 for any new information. Instead, for example, a user's webpage including the user applications can be updated automatically as relevant information becomes available.

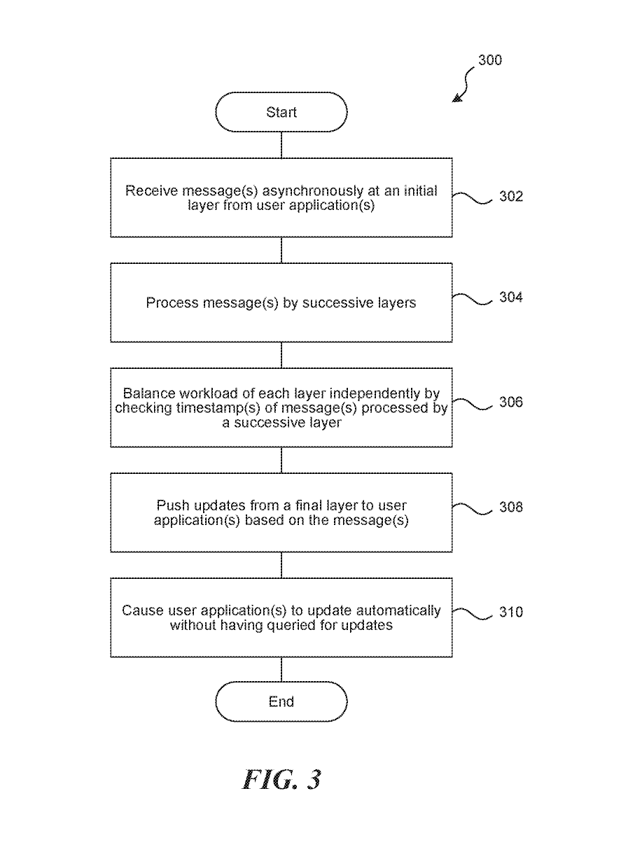

FIG. 3 is a flowchart illustrating a process 300 performed by the cloud computing architecture 12 according to some embodiments of the present disclosure. In step 302, the cloud computing architecture 12 receives one or more messages asynchronously from one or more user applications on the client devices 14. Specifically, the message(s) are received by an initial layer (e.g., the web API cluster layer 22) of the successive layers. In step 304, the message(s) are processed by asynchronously communicating the message(s) in order, layer-by-layer through the successive layers.

In step 306, a workload of each individual layer is balanced independently of the other layers. In particular, the load balancer 30 of the individual layer checks one or more timestamps of the message(s) when processed by that specific individual layer. In step 308, a final layer (e.g., the database cluster layer 28) pushes updates to the user application(s) based on the message(s). In step 310, the user application(s) are caused to automatically update without having queried for the updates.

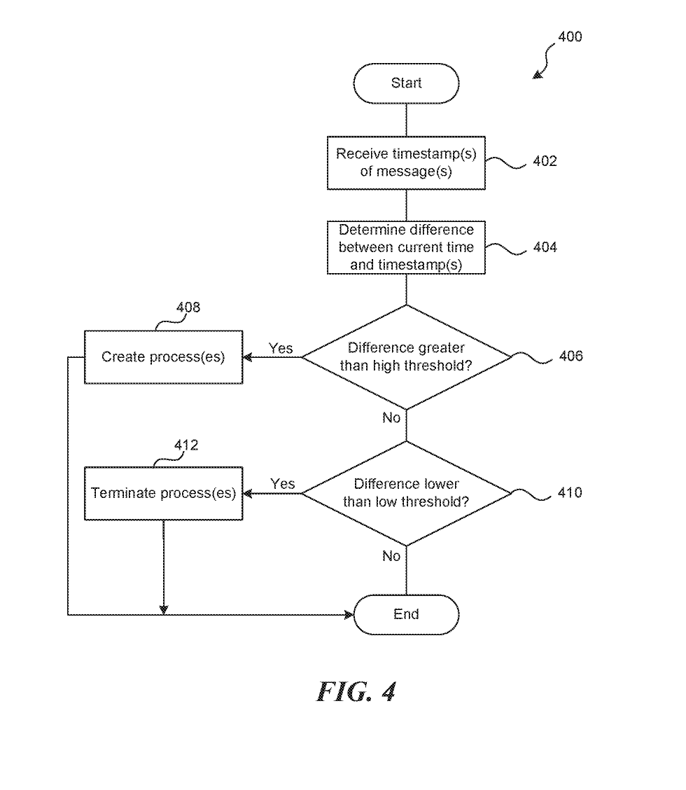

FIG. 4 is a flowchart illustrating a process 400 performed by the cloud computing architecture 12 for load balancing according to some embodiments of the present disclosure. In some embodiments, the process 400 can be implemented as an algorithm. In step 402, a load balancer 30 of a layer receives timestamp(s) of message(s). In some embodiments, a message can be timestamped upon being output by a layer.

In step 404, the load balancer determines a difference between a current time and the timestamp(s). In step 406, the load balancer 30 determines whether the difference is greater than a high threshold. If so, in step 408, one or more processes are created. As such, the layer can respond to a delay in processing by making more processes available. If not, in step 410, the load balancer 30 determines whether the difference is lower than a low threshold. If so, in step 412, one or more existing processes are terminated. As such, a layer can respond to rapid processing by terminating existing processes to balance the workload of the layer.

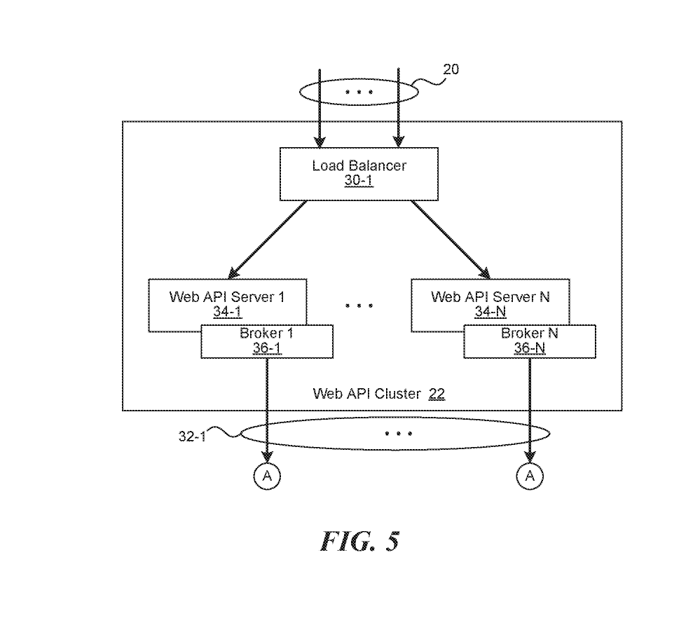

FIG. 5 is a block diagram of the web API cluster layer 22 of the cloud computing architecture 12 according to some embodiments of the present disclosure. The web API cluster layer 22 includes the load balancer 30-1, one or more web API servers 34 (referred to collectively as web API servers 34 and individually as web API server 34 or 34-1 through 34-N), and a broker 36 (e.g., broker 36-1 through 36-N) for each web API server 34. The load balancer 30-1 receives the incoming asynchronous requests of the user applications over the channel 20. The load balancer 30-1 can distribute the incoming asynchronous requests among the web API servers 34. Each web API server 34 includes a broker 36, which distributes the messages to an appropriate service cluster of the next layer (MQ cluster layer 24) via the channels 32-1.

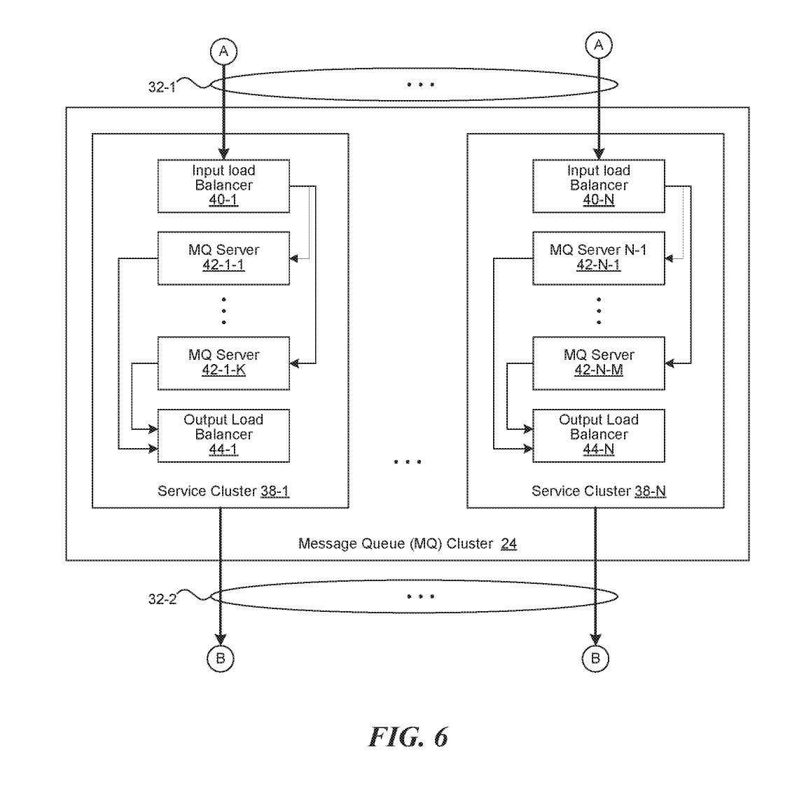

FIG. 6 is a block diagram of the MQ cluster layer 24 of the cloud computing architecture 12 according to some embodiments of the present disclosure. The MQ cluster layer 24 includes one or more service clusters 38 that receive the distributed messages from the brokers 36 of the web API cluster layer 22. As indicated above, the brokers 36 can send messages to service clusters 38 running in the MQ cluster layer 24.

The MQ cluster layer 24 includes a load balancer 30-2. In some embodiments, the load balancer 30-2 may include various components that collectively provide the functionality of a load balancer for the MQ cluster layer 24. For example, each service cluster 38 can include an input load balancer 40 (e.g., input load balancer 40-1 through 40-N), one or more MQ servers 42 (e.g., MQ servers 42-1-1 through 42-1-K and 42-N-1 through 42-N-M), and an output load balancer 44. The input load balancer 40 can distribute messages among the MQ servers 42. Each MQ server 42 produces and sends tasks to the output load balancer 44 (e.g., output load balancer 44-1 through 44-N). In some embodiments, an MQ server 42 can be an IBM WebSphere MQ or an Oracle Advanced Queuing. The output load balancer 44 can assign the tasks to an appropriate execute service queue of the next layer (micro service cluster layer 26) and deposit the task into the appropriate execute service queue. In some embodiments, each output load balancer 44 assigns a current timestamp to each task.

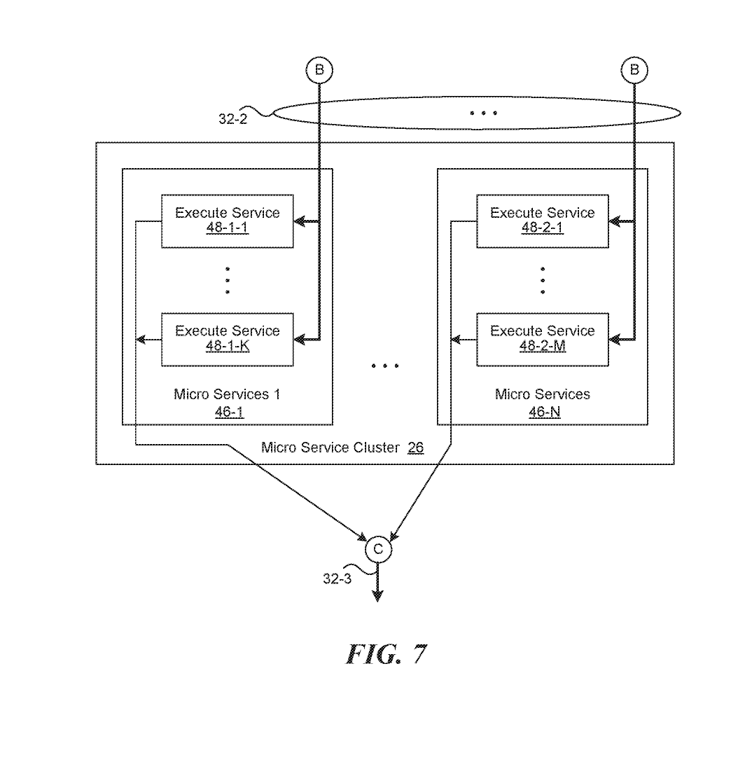

FIG. 7 is a block diagram of a micro service cluster layer 26 of the cloud computing architecture 12 according to some embodiments of the present disclosure. The micro service cluster layer 26 is the layer succeeding the MQ cluster layer 24 of the successive layers. The micro service cluster layer 26 includes one or more micro services 46 (e.g., micro services 46-1 through 46-N). Each micro service 46 includes one or more execute services 48 (e.g., execute services 48-1-1 through 48-1-K and 48-2-1 through 48-2-M). Each execute service 48 can fetch the assigned task from an execute service queue and perform the assigned task to provide an output, which is sent to a hash/modulo function of the next layer (database cluster layer 28). The micro service cluster layer 26 also includes a load balancer 30-3 (not shown). The load balancer 30-3 can be similar in operation to the load balancer 30-1 or 30-2 and, as such, is not described again here.

Each execute service 48 monitors a workload by checking a timestamp of each task received from the output load balancer 44 of the MQ cluster layer 24, and balances a workload by spawning or terminating copies of execute services 48. The difference between a current time and a timestamp is used to determine whether to spawn or terminate the copies. If the difference is greater than a high threshold (e.g., 10 milliseconds), each execute service 48 can spawn one or more copies of execute service 48. If the difference is less than a low threshold (e.g., 2 milliseconds), each execute service 48 that received the task will shut down after completing the task. In some embodiments, the execute service 48 in the micro service cluster layer 26 is a console running on a virtual machine.

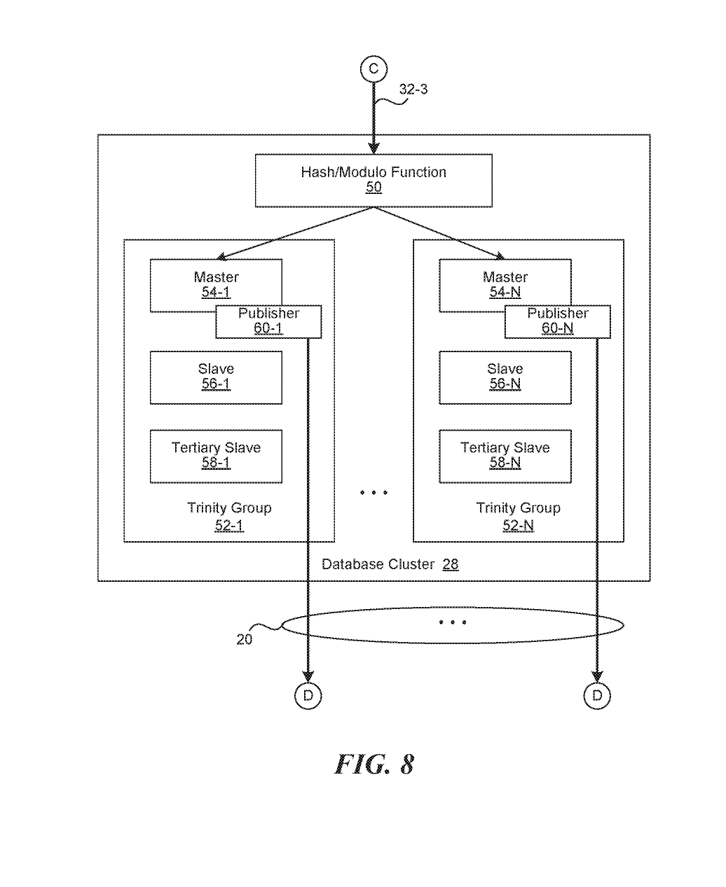

FIG. 8 is a block diagram of the database cluster layer 28 of the cloud computing architecture 12, according to some embodiments of the present disclosure. The database cluster layer 28 succeeds the micro service cluster layer 26. The database cluster layer 28 includes a load balancer 30-4 (not shown). The load balancer 30-4 can be similar in operation to any of the load balancers 30-1 through 30-3 and, as such, is not described again here.

The database cluster layer 28 includes a hash/modulo function 50 and one or more trinity groups 52 (e.g., trinity groups 52-1 through 52-N). Each trinity group 52 includes a master node 54 (e.g., master nodes 54-1 through 54-N), a slave node 56 (e.g., slave nodes 56-1 through 56-N), and a tertiary slave node 58 (e.g., tertiary slave nodes 58-1 through 58-N). Data is copied to the slave nodes (e.g., servers). The tertiary node 58 is a third server, where the shards of data are stored. In some embodiments, there are “n” numbers of “third servers” to shard data across for increased security measures. In some embodiments, the tertiary slave node 58 exists on a cloud machine. In some embodiments, the database cluster layer 28 can include a Redis Database Cluster.

Keys can provide a means to identify, access, and update information in the database cluster layer 28. The hash/modulo function 50 can hash a key and then take a modulus of it. The modulus returns an integer value which is an address used to identify a server. Hence, the modulus is an algorithm used to derive what server data was saved on. That is, the location of data can be determined based on the modulus.

Each master node 54 is coupled to a publisher 60 that can push updates to automatically update user applications, which may be included in webpages. As such, the user applications may be updated without receiving a query from the user applications or reloading the webpage that includes the user applications.

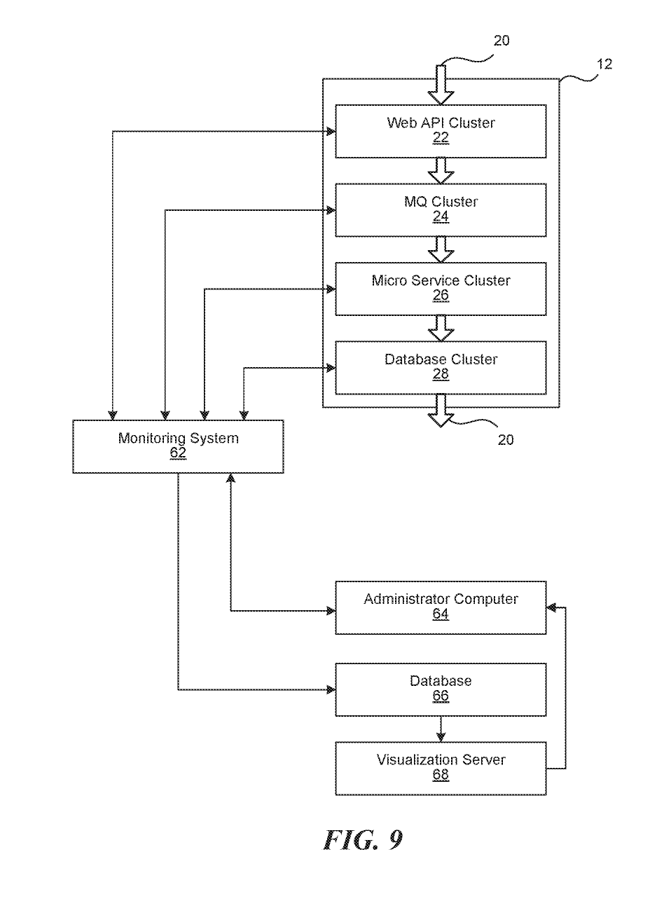

FIG. 9 is a block diagram including an independent monitoring system 62 that can automatically monitor the layers of the cloud computing architecture 12 of the system 10, according to some embodiments of the present disclosure. The monitoring system 62 monitors a workload of each of the layers 22 through 28 of the cloud computing architecture 12. A workload can be measured based on performance data such as resource consumption (e.g., CPU, memory, bandwidth) data or processing time data. If a workload of a layer is greater than a threshold, the monitoring system 62 can activate additional processes in that layer to help manage the workload. If the workload of the layer is below a threshold, the monitoring system 62 can deactivate existing processes in that layer because they are no longer needed.

In case an error occurs (which cannot be automatically corrected), the monitoring system 62 can send notifications to an administrator computer 64. In addition, the monitoring system 62 can log the data received (e.g., performance data) into a database 66. The monitoring system 62 can also send the logged system performance data to a visualization server 68, which in turn can send the visualized data to the administrator computer 64 for inspection.

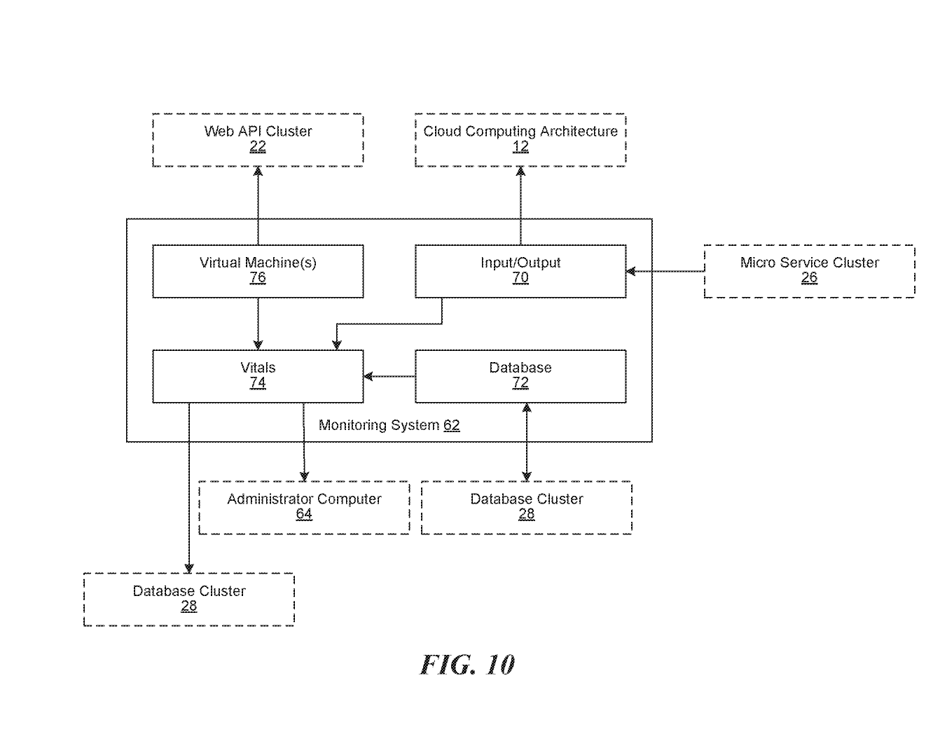

FIG. 10 is a block diagram of different services provided by the monitoring system 62 of FIG. 9, according to some embodiments of the present disclosure. The monitoring system 62 can include an input/output subsystem 70, monitor database 72, vitals subsystem 74, and virtual machines 76.

The input/output subsystem 70 can inject test data into the cloud computing architecture 12. In some embodiments, the test data is injected through the web API cluster layer 22 and propagates through the remaining layers. As such, the monitoring system 62 can monitor processing time of the test data through the cloud computing architecture 12. In some embodiments, the test data can be injected into any of the layers 22 through 28, and its processing time can be used for monitoring the cloud computing architecture 12. In some embodiments, the input/output subsystem 70 can send monitoring information to the vitals subsystem 74.

The monitor database 72 can query the database trinity groups 52 of the database cluster layer 28 to inquire about resource consumption and workload information of each database trinity group 52. For example, the monitor database 72 can use the queries to gather information about memory consumption, CPU consumption, an amount of data in each database trinity group 52 (e.g., memory consumption), and a number of clients connected to the cloud computing architecture 12. The monitor database 72 gathers the responses to the queries and analyzes them to determine whether the workload in the database cluster layer 28 is unbalanced (e.g., too much or too little relative to thresholds). If there is too much work, the monitor database 72 communicates to the database cluster layer 28 to activate more database trinity groups 52. If there is too little work, the monitor database 72 communicates to the database cluster layer 28 to deactivate one or more of the database trinity groups 52. The monitor database 72 can send this information to the vitals subsystem 74.

The virtual machines 76 can query virtual machines of the cloud computing architecture 12 about resource consumption of each virtual machine. For example, the virtual machines 76 can monitor the CPU, the memory, and the bandwidth consumption of each virtual machine. The virtual machines 76 can gather the responses to the queries and analyze them to determine whether a particular virtual machine is working inefficiently. The virtual machines 76 can send the information to the vitals subsystem 74.

The vitals subsystem 74 can receive information from the input/output subsystem 70, the monitor database 72, and the virtual machines 76. Every time a web API server 34, an MQ server 42, an execute service 48, or a database trinity group 52 is activated or deactivated, the vitals subsystem 74 can send a notification (such as an email or a text message) to the administrator computer 64. Further, the vitals subsystem 74 can send all the information received into the database cluster layer 28 or another a database.

In some embodiments, the visualization server 68 can gather the monitoring system vitals logs from the monitor database 72 and create a visual display of information that can be displayed on a monitor and analyzed manually.

The monitoring system 62 can monitor a workload of a layer by gathering performance data based on a test message injected into the cloud computing architecture 12. The performance data can be used to signal a layer to create one or more new processes or terminate one or more existing processes within the layer. The performance data may include timestamp information or resource consumption information.

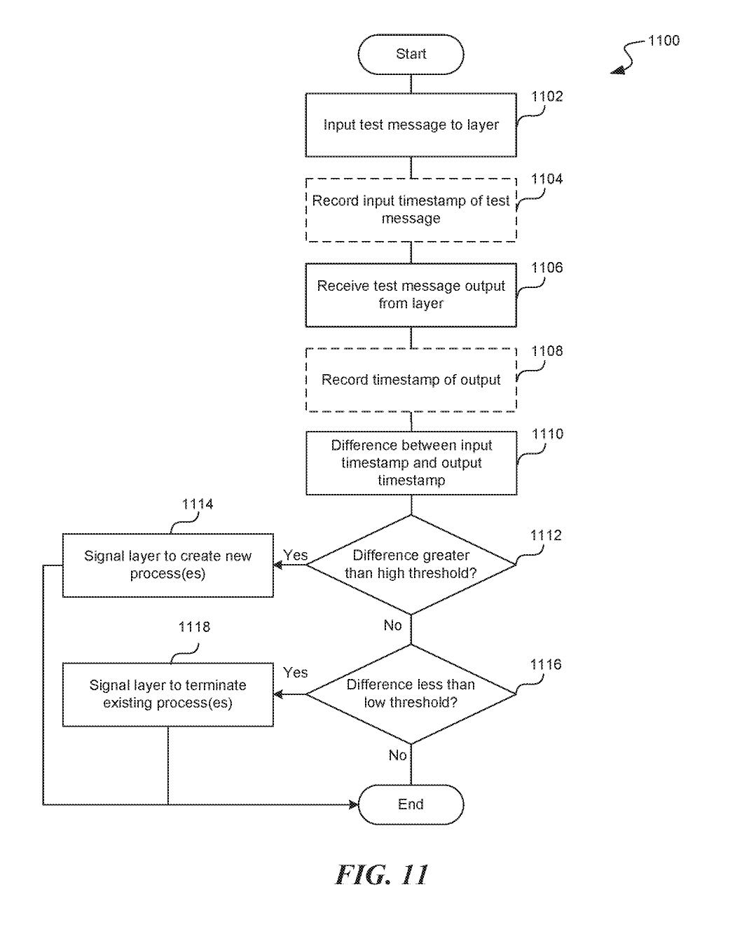

FIG. 11 is a flowchart of a process 1100 for workload balancing performed by the monitoring system 62, according to some embodiments of the present disclosure. In step 1102, the monitoring system 62 inputs a test message into the cloud computing architecture 12. In some embodiments, the process 1100 can be implemented as a workload monitoring algorithm running on the input/output subsystem 70. For example, the input/output subsystem 70 can input test data into the cloud computing architecture 12 through the web API cluster layer 22 to monitor a processing time of the test data through the cloud computing architecture 12. In some embodiments, the test message can be input directly into any layer of the cloud computing architecture 12.

In optional step 1104, the monitoring system 62 can record a timestamp of when the test message was input to the cloud computing architecture 12. For example, after inputting the test message into the cloud computing architecture 12, the input/output subsystem 70 can record the current time as the input timestamp.

In step 1106, the monitoring system 62 receives an output from the cloud computing architecture 12, which is generated based on the test message. In optional step 1108, the monitoring system records a timestamp for the output. For example, after the test data is processed through the cloud computing architecture 12, the input/output subsystem 70 can receive the test data with timing information from the micro service cluster layer 26. After this data has been received, the input/output subsystem 70 can record the current time as an output timestamp.

In step 1110, a difference between the input timestamp and output timestamp of the test message can be used to obtain performance information about any of the layers 22 through 28. For example, the timing information can record the time taken for the test data to be processed by a single layer of the successive layers of the cloud computing architecture 12.

In steps 1112, the monitoring system 62 determines whether the difference is greater than a high threshold. If so, in step 1114, the monitoring system 62 signals a layer to create one or more new processes to balance the workload. For example, if the test data processing in a particular layer is too slow (i.e., the time taken for the data to be processed is above a high threshold), the monitoring system 62 signals the particular layer to create additional processes in the layer.

If not, in step 1116, the monitoring system 62 determines whether the difference is less than a low threshold. If so, in step 1118, the monitoring system 62 signals the layer to terminate one or more processes to balance the workload. For example, if test data processing in the particular layer is too fast (i.e., the time taken for the data to be processed is below a low threshold), the monitoring system 62, signals the particular layer to deactivate some of the processes in any of the layers 22 through 28.

For example, after inputting the test data into the cloud computing architecture 12 through the web API cluster layer 22, the monitoring system 62 can receive the test data with timing information. The received test data with timing information can indicate that processing the test message through the MQ cluster layer 24 took 100 milliseconds, which is above the high threshold (hence, too slow). As a result, the monitoring system 62 can communicate to the web API cluster layer 22 to activate more web API servers 34.

When obtaining performance data by measuring resource consumption information (rather than timestamps), the monitoring system 62 can signal a layer to create one or more new processes when the resource consumption information indicates that resource consumption is greater than a high threshold. The monitoring system 62 can signal a particular layer to terminate an existing process within the test layer when the resource consumption information indicates that resource consumption by the test layer is less than a low threshold. In some embodiments, the performance data can be used to generate a graphical visualization that can be generated on demand.

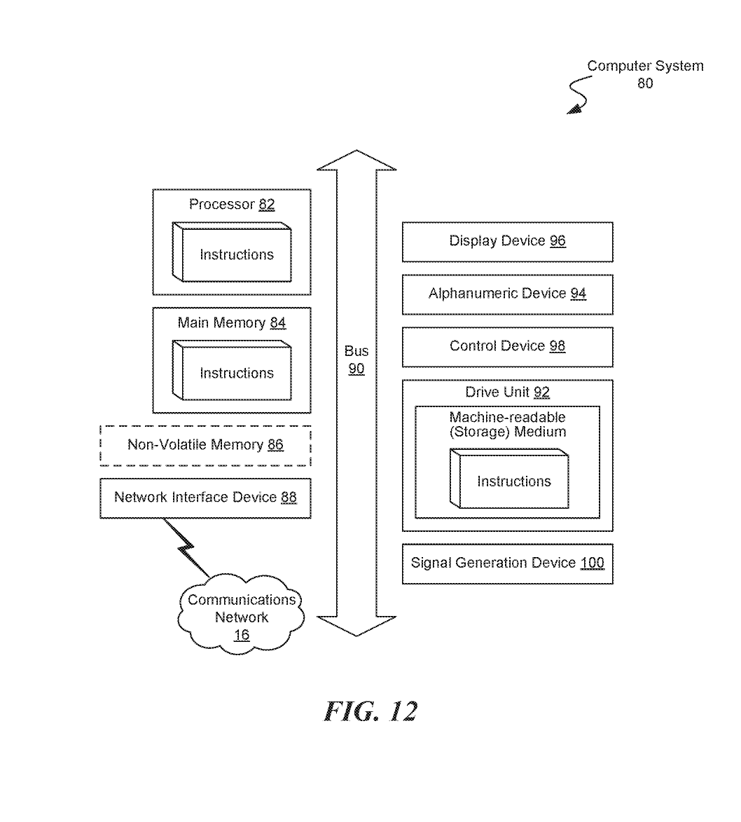

FIG. 12 is a block diagram illustrating a computer operable to implement instructions causing the computer to perform the disclosed technologies, according to some embodiments of the present disclosure. The computer system 80 includes a processor 82, main memory 84, non-volatile memory 86, and a network interface device 88. Various common components (e.g., cache memory) are omitted for illustrative simplicity. The computer system 80 is intended to illustrate a hardware device on which any of the components described above can be implemented. The computer system 80 can be of any applicable known or convenient type. The components of the computer system 80 can be coupled together via a bus 90 or through some other known or convenient device.

This disclosure contemplates the computer system 80 taking any suitable physical form. As example, and not by way of limitation, computer system 80 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these).

Where appropriate, the computer system 80 may include one or more computer subsystems, can be unitary or distributed, can span multiple locations, can span multiple machines, and can reside in the cloud, which may include one or more cloud components in one or more networks. Where appropriate, one or more computer systems 80 may perform, without substantial spatial or temporal limitation, one or more steps of one or more methods described or illustrated herein. As an example and not by way of limitation, one or more computer systems 80 may perform in real time or in batch mode one or more steps of one or more methods described or illustrated herein. One or more computer systems 80 may perform at different times or at different locations one or more steps of one or more methods described or illustrated herein, where appropriate.

The processor 82 may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The main memory 84 is coupled to the processor 82 by, for example, the bus 90. The main memory 84 can include, by way of example but not limitation, random access memory (RAM) such as dynamic RAM (DRAM) and static RAM (SRAM). The main memory 84 can be local, remote, or distributed.

The bus 90 also couples the processor 82 to the non-volatile memory 86 and drive unit 92. The non-volatile memory 86 can be a magnetic floppy or hard disk, a magnetic-optical disk, an optical disk, a read-only memory (ROM) (e.g., a CD-ROM, EPROM, or EEPROM), a magnetic or optical card, or another form of storage for large amounts of data. Some of this data is often written, by a direct memory access process, into memory during execution of software (including machine readable instructions) in the computer system 80.

The non-volatile memory 86 can be local, remote, or distributed. The non-volatile memory 86 is optional because systems can be created with all applicable data available in memory. A typical computer system will usually (but not necessarily) include at least a processor, memory, and a device (e.g., a bus) coupling the memory to the processor.

Software is typically stored in the non-volatile memory 86 and/or the drive unit 92 (e.g., instructions on a machine-readable storage medium). Indeed, storing an entire large program in memory may not even be possible. Nevertheless, for software to run, it is moved to a computer readable location appropriate for processing (e.g., the main memory 84). Even when software is moved to the main memory 84 for execution, the processor 82 will typically make use of hardware registers to store values associated with the software, and a local cache that, ideally, serves to speed up execution.

As used herein, a software program is assumed to be stored at any known or convenient location (from non-volatile storage to hardware registers) when the software program is referred to as “implemented in a computer-readable medium.” A processor (e.g., processor 82) is considered to be “configured to execute a program” when at least one value associated with the program is stored in a register readable by the processor 82.

The bus 90 also couples the processor 82 to the network interface device 88. The network interface device 88 can include one or more of a modem or network interface. It will be appreciated that a modem or network interface can be considered to be part of the computer system 80. The network interface device 88 can include an analog modem, ISDN modem, cable modem, token ring interface, satellite transmission interface (e.g., “direct PC”), or other interfaces for coupling the computer system 80 to other computer systems.

The computer system 80 can include one or more input and/or output devices. The I/O devices can include, by way of example but not limitation, a keyboard (e.g., alphanumeric device 94), a mouse or other pointing device, disk drives, printers, a scanner, and other input and/or output devices, including a display device 96. The display device 96 can include, by way of example but not limitation, a cathode ray tube (CRT), liquid crystal display (LCD), or some other applicable known or convenient display device. The computer system 80 may also include a control device 98 (e.g., controller) and a signal generation device 100. For simplicity, it is assumed that controllers of any devices not depicted in the example of FIG. 12 reside as an interface.

In operation, the computer system 80 can be controlled by operating system software that includes a file management system, such as a disk operating system. One example of operating system software with associated file management system software is Microsoft Windows® and their associated file management systems. Another example of operating system software with its associated file management system software is the Linux™ operating system and its associated file management system. The file management system is typically stored in the non-volatile memory 86 and/or drive unit 92 and causes the processor to execute the various acts required by the operating system to input and output data and to store data in the memory, including storing files on the non-volatile memory 86 and/or drive unit 92.

Some portions of the disclosure may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In some embodiments, the computer system 80 operates as a standalone device or may be connected (e.g., networked) to other machines. In a networked deployment, the computer system 80 may operate in the capacity of a server or a client machine in a client-server network environment, or as a peer machine in a peer-to-peer (or distributed) network environment.

The computer system 80 may include a server computer, a client computer, a desktop computer, a tablet computer, a laptop computer, a set-top box (STB), any handheld mobile device, a processor, a telephone, a web appliance, a network router, switch or bridge, or any machine capable of executing a set of instructions (sequential or otherwise) that specifies actions to be taken by that computer system 80.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally, regardless of the particular type of machine or computer-readable media used to actually effect the distribution.

Further examples of machine-readable storage media, machine-readable media, or computer-readable (storage) media include, but are not limited to, recordable-type media such as volatile and non-volatile memory devices, floppy and other removable disks, hard disk drives, optical disks (e.g., Compact Disk Read-Only Memory (CD ROMS) and Digital Versatile Disks (DVDs)), among others, and transmission-type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of a charge, or a release of a stored charge. Likewise, in other memory devices, a change of state may comprise a physical change or transformation in magnetic orientation, or a physical change or transformation in molecular structure, such as from crystalline to amorphous or vice versa. The foregoing is not intended to be an exhaustive list of examples in which a change in state of a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. For example, in some embodiments, communications between any and all the cluster layers of the cloud computing architecture may be conducted in a variety of manners including being partially or not successive, partially or fully sequential, partially or fully bi-directional or unidirectional, or combinations thereof.

Numerous specific details are described to provide a thorough understanding of the disclosure. However, in certain instances, well-known or conventional details are not described in order to avoid obscuring the description.

Reference to “one embodiment” means that a particular feature, structure, or characteristic described in connection with the embodiment is included in at least one embodiment of the disclosure. The appearances of the phrase “in some embodiments” are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.”

As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application.

While processes or blocks are presented in a given order, alternative embodiments may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples; alternative implementations may employ differing values or ranges.

The teachings of the disclosure provided herein can be applied to other systems, not necessarily the system described above. The elements and acts of the various embodiments described above can be combined to provide further embodiments.

These and other changes can be made to the disclosure in light of the above description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein.

As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the claims should not be construed to limit the disclosure to any specific embodiments, unless the disclosure explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim, other aspects may likewise be embodied as a means-plus-function claim, or in other forms, such as being embodied in a computer-readable medium. (Any claims intended to be treated as a means-plus-function claim will begin with the words “means for”.) Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results, according to the embodiments of the present disclosure, are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of the embodiments are described in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it can also be convenient, at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described herein.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used herein has been principally selected for readability and instructional purposes, and it may not have been selected to delineate or circumscribe the inventive subject matter. It is therefore intended that the scope of the disclosure be limited not by the embodiments, but rather by any claims that issue on an application based hereon. Accordingly, the disclosed embodiments are intended to be illustrative, but not limiting, of the scope of the disclosure, which is set forth in the claims below.

1. A cloud-based computing architecture that includes successive layers of scalable clusters of computing devices operable to process asynchronous requests received over a network from applications on client devices and operable to asynchronously communicate messages over channels successively layer-by-layer where each layer includes a load balancer to balance a workload of the layer independent of any other layer such that the cloud-based computing architecture provides a massively-scalable, asynchronous backend cloud service, the cloud-based computing architecture comprising:
a plurality of successive layers configured to process a plurality of asynchronous requests received from a plurality of applications on a plurality of client devices, each layer including a load balancer configured to balance a load of the layer independent of any other layer of the plurality of successive layers; and
a plurality of channels communicatively coupling the plurality of successive layers such that any layer of the plurality of successive layers is configured to communicate asynchronously with a successive layer of the plurality of successive layers over one or more channels of the plurality of channels.

2. The cloud-based computing architecture of claim 1, wherein the plurality of successive layers comprises a web application program interface, API, cluster layer configured to receive the plurality of asynchronous requests from the plurality of applications on client devices, the web API cluster layer including:
a load balancer of the plurality of load balancers configured to distribute the plurality of asynchronous requests thereby providing a plurality of distributed asynchronous requests;
one or more web API servers configured to receive the plurality of distributed asynchronous requests; and
one or more brokers communicatively coupled with the one or more web API servers, respectively, and configured to distribute messages to a layer of the of the plurality of successive layers succeeding the web API cluster layer thereby providing distributed messages.

3. The cloud-based computing architecture of claim 2, wherein the layer succeeding the web API cluster layer is a message queue, MQ, cluster layer, the MQ cluster layer comprising:
one or more service clusters configured to receive the distributed messages from the one or more brokers, respectively, each service cluster including:
an input load balancer configured to distribute the distributed messages to one or more MQ servers;
the one or more MQ servers, each MQ server configured to produce tasks and send the tasks to an output load balancer; and
the output load balancer configured to assign the tasks to an execute service of a plurality of execute services of a layer of the of the plurality of successive layers succeeding the MQ cluster layer thereby providing distributed tasks.

4. The cloud-based computing architecture of claim 3, wherein each of the output load balancers is configured to timestamp each of the received tasks.

5. The cloud-based computing architecture of claim 4, wherein each of the output load balancers is configured to deposit the assigned task into an appropriate execute service queue.

6. The cloud-based computing architecture of claim 5, wherein the layer succeeding the MQ cluster layer is a micro service cluster layer, the micro service cluster layer comprising:
one or more micro services, each micro service including one or more execute services, each execute service configured to fetch the assigned task from the execute service queue, perform the assigned task, thereby providing an output, and send the output to a layer of the of the plurality of successive layers succeeding the micro service cluster layer, thereby providing distributed sent outputs.

7. The cloud-based computing architecture of claim 6, wherein each execute service monitors a workload by checking the timestamp of each task received from the output load balancer, and balances the workload by spawning or terminating copies of execute services.

8. The cloud-based computing architecture of claim 7, wherein each execute service is configured to spawn one or more copies of execute services when a difference between a current time and a timestamp of a task is greater than a high threshold amount and configured to terminate the execute services after completing the task when the difference is less than a low threshold amount, the high threshold amount being greater than the low threshold amount.

9. The cloud-based computing architecture of claim 8, wherein the high threshold amount is 10 milliseconds, and the low threshold amount is 2 milliseconds.

10. The cloud-based computing architecture of claim 6, wherein the micro service cluster is a console running on a virtual machine.

11. The cloud-based computing architecture of claim 6, wherein the layer succeeding the micro service cluster layer is a database cluster layer, the database cluster layer comprising:
a hash/modulo function; and
one or more trinity groups, each trinity group including a master node, a slave node, and a tertiary slave node.

12. The cloud-based computing architecture of claim 11, wherein the tertiary slave node exists on a cloud machine.

13. The cloud-based computing architecture of claim 11, wherein each master node is associated with a publisher configured to push updates that automatically update a webpage without receiving a query or reloading the webpage.

14. A method performed by a cloud-based computing architecture including a plurality of successive layers, the method comprising:
receiving one or more messages asynchronously from a plurality of applications on a plurality of client devices, the one or more messages being received by an initial layer of the plurality of successive layers;
processing the one or more messages by asynchronously communicating in successive order by each layer of the plurality of successive layers;
balancing a workload of an individual layer independent of other layers of the plurality of successive layers by checking one or more timestamps of the one or more messages when processed by the individual layer;
pushing updates from a final layer of the plurality of successive layers to the plurality of applications on the plurality of client devices based on the one or more messages; and
causing the plurality of applications on the plurality of client devices to update with the updates without having queried for the updates.

15. The method of claim 14, wherein the individual layer comprises a load balancer that performs the balancing of the workload of the individual layer, the method performed by the load balancer comprising:
receiving the one or more timestamps;
creating one or more processes when a difference between the current time and the one or more timestamps is greater than a high threshold; and
terminating one or more existing processes when the difference is less than a low threshold.

16. A method performed by a monitoring system operable to monitor a cloud-based computing architecture including a plurality of successive layers, the method comprising:
inputting a test message into a layer of the plurality of successive layers of the cloud-based computing architecture;
monitoring a workload of the layer by gathering performance data based on the test message; and
signaling the layer to create one or more new processes or terminate one or more existing processes within the layer depending on the performance data.

17. The method of claim 16, further comprising:
generating a visualization based on the performance data, the visualization being provided on demand.

18. The method of claim 16, wherein the performance data comprises at least one of timestamp information or resource consumption information.

19. The method of claim 18, wherein the timestamp information comprises an input timestamp corresponding to a time when the test data was input to the layer, and an output timestamp corresponding to a time when the test data was output by the layer, the method further comprising:
signaling the layer to create one or more new processes within the layer when a difference between the output timestamp and the input timestamp is greater than a high threshold; and
signaling the layer to terminate one or more existing processes within the layer when a difference between the output timestamp and the input timestamp is below a low threshold.

20. The method of claim 18, further comprising:
signaling the layer to create one or more new processes within the layer when the resource consumption information indicates that resource consumption by the layer is greater than a high threshold; and
signaling the layer to terminate an existing process within the layer when the resource consumption information indicates that resource consumption by the layer is less than a low threshold.
